(19) United States
(12) Patent Application Publication
(10) Pub. No.: US 2021/0213969 A1
(43) Pub. Date: Jul. 15, 2021

(54) UTILIZATION OF A LOCALLY CUSTOMARY BEHAVIOR FOR AUTOMATED DRIVING FUNCTIONS

(71) Applicant: Robert Bosch GmbH, Stuttgart (DE)

(72) Inventors: Carsten Hasberg, Ilsfeld-Auenstein (DE); Tobias Strauss, Obersulm (DE)

(21) Appl. No.: 17/141,908

(22) Filed: Jan. 5, 2021

(30) Foreign Application Priority Data
Jan. 9, 2020 (DE) 102020200176.6

(51) Int. Cl. B60W 60/00; G01C 21/34; G01C 21/00

(52) U.S. Cl. CPC B60W 60/001; G01C 21/3484; G01C 21/3492; G01C 21/3841; B60W 2556/65; B60W 2420/52; B60W 2556/10; B60W 2556/50; B60W 2420/42

(57) ABSTRACT

A method for utilizing observed locally customary behavior from historical data sets in vehicle surroundings by a control unit. Historical data sets of vehicle trajectories of at least one first vehicle and/or at least one second vehicle are received.

A locally customary behavior of the first vehicle and/or of the second vehicle is ascertained from the historical data sets. A registered behavior of the first vehicle, of at least one third vehicle or a digital map being checked for deviations based on the ascertained locally customary behavior. When a deviation of the locally customary behavior from a registered behavior of the first vehicle, a registered behavior of a third vehicle, or a deviation of the locally customary behavior from the digital map is established, the execution of at least one function is initiated. A control unit, a computer program, and a machine-readable memory medium, are also described.

### CROSS REFERENCE

The present application claims the benefit under 35 U.S.C. § 119 of German Patent Application No. DE 102020200176.6 filed on Jan. 9, 2020, which is expressly incorporated herein by reference in its entirety.

### FIELD

The present invention relates to a method for utilizing an observed locally customary behavior from historical data sets in vehicle surroundings. The present invention furthermore relates to a control unit, to a computer program, and to a machine-readable memory medium.

### BACKGROUND INFORMATION

Automated driving functions and vehicles including automated driving functions are increasingly gaining in importance. Up-to-date and precise maps are essential for a successful implementation of automated driving functions.

Through the use of digital maps for automated driving functions, it is possible to compensate for limited sensor ranges and hidden portions of scanning areas of the sensors of vehicles and to enable a complete surroundings perception.

Digital maps may furthermore be created outside vehicle surroundings using a usually higher computing power, by which more complex processing algorithms and a larger data volume may be processed and provided. The utilization of the maps by a vehicle-side control unit requires a lower computing power than the vehicle-external creation of the maps.

During the utilization of the maps by vehicle-side control units, usually localization layers and planning layers of digital maps are received and used for localization and behavior planning. In the process, usually exclusively the static pieces of information of the received digital maps are used for the further processing by the vehicle-side control unit. A consideration of dynamic pieces of vehicle information, for example of locally customary vehicle trajectories or speeds, is not taken into consideration during the vehicle-side localization and behavior planning.

### SUMMARY

It is an object of the present invention to provide a method for improving automated driving functions and for using dynamic pieces of vehicle information.

This object may be achieved with the aid of example embodiments of the present invention. Advantageous embodiments of the present invention are described herein.

According to one aspect of the present invention, a method for utilizing observed locally customary behavior from historical data sets in vehicle surroundings by a control unit is provided. The vehicle surroundings may be a perimeter around a first vehicle or general surroundings for operating vehicles, such as a road or a road network.

In accordance with an example embodiment of the present invention, in one step, historical data sets of vehicle trajectories of at least one first vehicle and/or at least one second vehicle are received. The at least one second vehicle may, for example, be a mapping vehicle or an arbitrary vehicle, which may contribute to the creation of digital maps. The historical data sets may already be stored in digital maps or be usable for the creation of digital maps in the process.

A locally customary behavior of the first vehicle and/or of the second vehicle is ascertained from the historical data sets. In the process, a customary behavior of vehicles, in particular, with respect to selected trajectories and/or speeds, may be inferred from the historical data sets. For example, drivers familiar with the location may drive faster or more slowly in certain route segments than the signage suggests. In the process, depending on the particular road segment, the driving direction may also be relevant for an assessment of the correctness of the route planning.

Based on the ascertained locally customary behavior, a registered or presently executed behavior of the first vehicle, of at least one third vehicle or a digital map is checked for deviations. By using the locally customary behavior, it is possible to ascertain errors and discrepancies and use them for an improvement of automated driving functions.

Thereafter, when a deviation of the locally customary behavior from a registered behavior of the first vehicle, a registered behavior of a third vehicle, or a deviation of the locally customary behavior from the digital map is established, the execution of at least one function is initiated. The at least one function may thus be a response to deviations or errors, which are ascertained by using historical data sets and locally customary behavioral patterns of the vehicles.

The at least one first vehicle may, for example, be an ego-vehicle. The at least one second vehicle may be a vehicle which, in the past, contributed to the collection of historical data sets. The at least one third vehicle may, for example, be an arbitrary road user. In particular, the third vehicle may be detected by the first vehicle with the aid of sensors.

The historical data sets preferably exhibit the behavior of road users and are available during the mapping in the form of ego and outside trajectories. As a result of the method, these dynamic pieces of information may be optimally used. In particular, a systematic utilization of the observed or locally customary behavior from historical data sets may be achieved.

The dynamic data sets or the locally customary behavior may be rendered accessible for utilization. For this purpose, the ego and outside trajectories which are processed in the mapping data sets may be separated or stored in an additional map level.

According to another aspect of the present invention, a control unit is provided, the control unit being configured to carry out the method. The control unit may, for example, be a vehicle-side control unit, a vehicle-external control unit or a vehicle-external server unit, such as a cloud system.

According to one aspect of the present invention, moreover a computer program is provided, encompassing commands which, during the execution of the computer program by a computer or a control unit, prompt the computer to carry out the method according to the present invention. According to another aspect of the present invention, a machine-readable memory medium is provided, on which the computer program according to the present invention is stored.

The vehicle may be operable in an assisted, semi-automated, highly automated and/or fully automated or driverless manner according to the BASt standard.

The vehicle may, for example, be configured as a passenger car, a truck, a robo taxi and the like. The vehicle is not limited to an operation on roads. Rather, the vehicle may also be a water craft, an aircraft, such as a transport drone, for example, and the like.

As a result of the method for utilizing locally customary behavior from historical data sets, the safety in road traffic may be enhanced since the ego behavior planning is able to take a typical driving behavior at a certain location into consideration. Furthermore, the planning task in the vehicle may be technically simplified as a result of the storage of the historical data sets in the digital map data. In particular, the requirement with regard to the computing power during the execution of planning tasks may be decreased.

Moreover, errors during the mapping and the localization, as well as the classification of other road users, may be avoided by the method. A digital map which is released for the automated operation may be evaluated by a comparison to the locally customary behavior.

According to one exemplary embodiment, an adaptation of a driving behavior and/or of a trajectory of the first vehicle is carried out as a function of a classification of a digital map or of the third vehicle.

The classification of the digital map may, for example, be carried out as “usable,” “not usable,” “up-to-date” or as “not up-to-date.”

Furthermore, an adaptation of the behavior of the first vehicle or a classification of the road user as a special purpose vehicle may be implemented in response to deviations of a detected behavior of a road user or of the third vehicle from a locally customary behavior.

The utilization of the historical data sets may, for example, take place on the control unit configured as a cloud during the mapping. For example, ambiguities of the static surroundings may occur as error sources during a graph SLAM method usable for the mapping. Such ambiguities may, for example, occur during recurring patterns such as traffic lane markings. During the correction of the ambiguities, traffic lanes may “shift.” Contradictions during the comparison of historical or locally customary behavior of different historical data sets may help identify such errors.

According to one further specific embodiment of the present invention, deviations of the digital map are identified based on a comparison of driving directions and/or speed profiles of the locally customary behavior.

Mapping errors may be uncovered during a comparison of driving directions, the orientation of the trips from the locally customary behavior not coinciding with the driving direction in a lane.

The use of speed profiles may be used for identifying errors in the orientation of traffic lanes of the digital map. For example, an inadvertent superimposition of an acceleration lane with a right traffic lane of an expressway during the mapping may be ascertained by a comparison of speed profiles from the locally customary behavior, and may subsequently be corrected.

In one further exemplary embodiment, the ascertained locally customary behavior is checked for deviations for checking ambiguous results in static surroundings during a mapping and/or a localization with the aid of instantaneously ascertained data sets of a digital map. As a result of this check, discrepancies which arose due to corrections or the handling of ambiguities during the mapping may be identified. For example, incorrectly assigned traffic lanes or driving directions may be ascertained by comparisons with locally customary driving directions and trajectories.

According to another specific embodiment of the present invention, the data sets of the digital maps are classified as not being up-to-date when a deviation is established. Such a classification may be carried out when a deviation of the locally customary behavior from a registered behavior of the first vehicle, a registered behavior of a third vehicle, or a deviation of the locally customary behavior from the digital map is established. Based on this evaluation of the up-to-dateness of the digital map, the classification may be carried out as a response to or as a function of the established deviation.

In the process, the digital map may be classified as being outdated when the reality changes. Accordingly, a release of the digital map is required to be able to employ the map in safety-critical functions. One option is to support the release by a comparison between observed behavior and historical behavior or the locally customary behavior. If the instantaneously observed behavior and the historical behavior do not match, this indicates an outdated digital map.

According to another exemplary embodiment of the present invention, a classification, in particular, as an outlier or as a special purpose vehicle, of the at least one third vehicle or road user is carried out based on the instantaneously registered behavior of the third vehicle and the comparison to the ascertained locally customary behavior. In the process, the classification is carried out as a function which responds to an established deviation. In the process, a plausibility check of the behavior of the third vehicle may be carried out.

The locally customary behavior may be utilized on the part of the vehicle to assess other road users. To evaluate the behavior of other road users and include it in the ego behavior planning in the best possible manner, it is necessary to classify the relevant road users.

For example, a police car or an ambulance may behave differently from a locally customary behavior. A comparison to historical or locally customary behavior may help here to identify outliers, such as the police vehicle, which may negotiate a one-way road in the opposite direction.

According to another specific embodiment of the present invention, a driving behavior of the first vehicle is adapted to the locally customary behavior when a deviation of the locally customary behavior from a registered behavior of the first vehicle is established. For example, it is difficult for a driver not familiar with the location to decide on a rural road when a passing maneuver may be carried out safely. Corresponding problems may also be applied to vehicles operated in an automated manner. The road geometry as well as rules, such as “no-passing zone” and “speed of 100 km/h permitted” for example, are present in the planning layer of the map. These pieces of information of the planning layer or planning level may be less helpful, depending on the situation. For example, pieces of information about the speed to be expected of oncoming traffic and the frequency of successful passing maneuvers at the instantaneous location may provide further assistance for carrying out a safe passing maneuver at a suitable location. Such pieces of information may be derived from the locally customary behavior.

The locally customary behavior may include historical trajectories, driving directions, speed profiles and the like, which are present in a location-specific manner.

When the behavior of a manually steered third vehicle in the vehicle surroundings of the first vehicle deviates from the historical behavior, the first vehicle or the ego-vehicle may be warned, and the third vehicle may be classified as an outlier. In the process, it is possible to signal to the first vehicle that the vehicle surroundings are an unsuitable location for passing maneuvers or that the speed is too high. In the process, a general speed limit may also be set in the first vehicle to minimize a safety risk. The speed limit, for example to a maximum of 80 km/h, may be configured by the control unit on straight sections and/or curve sections.

According to another exemplary embodiment of the present invention, the ascertained locally customary behavior is taken into consideration as a prioritized suggestion during an implementation of an automated driving function.

According to another specific embodiment of the present invention, the ascertained locally customary behavior is taken into consideration during a planning of the automated driving function.

In this way, the locally customary behavior may be used in the vehicle during the behavior planning for the implementation of automated driving functions. To select the ego behavior of the first vehicle, the historical or locally customary behavior may supply an advantageous suggestion. In the process, a planning algorithm may orient itself at the locally customary behavior, and thus at a behavior of other vehicles in the past at a specific location.

For example, when driving across a complicated intersection, the control unit may form a statistical mean value from the locally customary behavior of other road users in the past and control the first vehicle corresponding to the averaged behavior.

Preferred exemplary embodiments of the present invention are described in greater detail hereafter based on highly simplified schematic representations.

### BRIEF DESCRIPTION OF THE DRAWINGS

FIG. 1 shows a schematic top view onto vehicle surroundings, in accordance with an example embodiment of the present invention.

FIG. 2 shows a schematic flowchart for illustrating a utilization of locally customary behavior in a digital map, in accordance with an example embodiment of the present invention.

FIG. 3 shows a schematic flowchart for illustrating a method for utilizing observed locally customary behavior from historical data sets according to one specific embodiment of the present invention.

### DETAILED DESCRIPTION OF EXAMPLE EMBODIMENTS

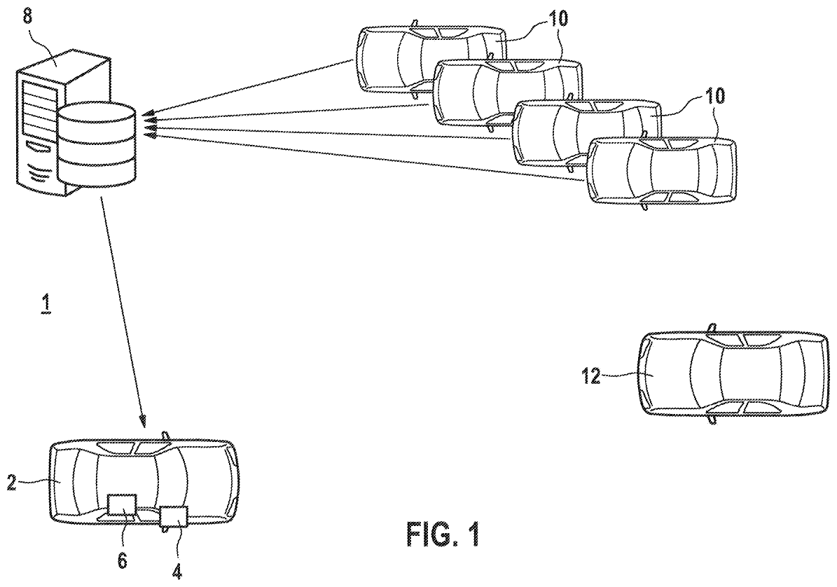

FIG. 1 shows a schematic top view onto vehicle surroundings 1. An exemplary first vehicle 2, which is operable in an automated manner according to the BASt standard, is present in vehicle surroundings 1.

For carrying out automated driving functions, first vehicle 2 includes a surroundings sensor system 4 and a vehicle-side control unit 6. Control unit 6 is able to receive measured data of surroundings sensor system 4 and, based on the measured data, carry out a control of first vehicle 2.

Surroundings sensor system 4 may, for example, include camera sensors, LIDAR sensors, radar sensors and the like.

First vehicle 2 may receive data of a digital map from a vehicle-external control unit 8 or an external server unit. Vehicle-external control unit 8 may, for example, be configured as a cloud.

The data of the digital map serve first vehicle 2 for the implementation of localization functions and planning functions. To be able to optimize these functions of first vehicle 2, the data of the digital map include historical data sets and/or data regarding a locally customary behavior.

Such data of the locally customary behavior may be obtained from one or multiple second vehicle(s) 10. For example, second vehicles 10 may be employed as mapping vehicles, and may thus provide their trajectories and measured data to vehicle-external control unit 8.

Vehicle-external control unit 8 may create digital maps, based on the measured data and trajectories of second vehicles 10, and ascertain data of the locally customary behavior from the historical data sets or measured data of second vehicles 10.

Based on the received data regarding the locally customary behavior, first vehicle 2 may implement a verification or check of the digital map or of a third vehicle 12 or of a road user.

For example, control unit 6 of first vehicle 2 may check whether a road user 12 is driving corresponding to the locally customary behavior or deviates from this behavior. If a deviation is established, road user 12 may be classified as a special purpose vehicle or as an exception. Based on such a classification of the at least one road user 12, a driving style of first vehicle 2 may be set as more cautious by control unit 6.

First vehicle 2, second vehicle 10, and third vehicle 12 may also each appear in a plurality and are not limited to a specific number.

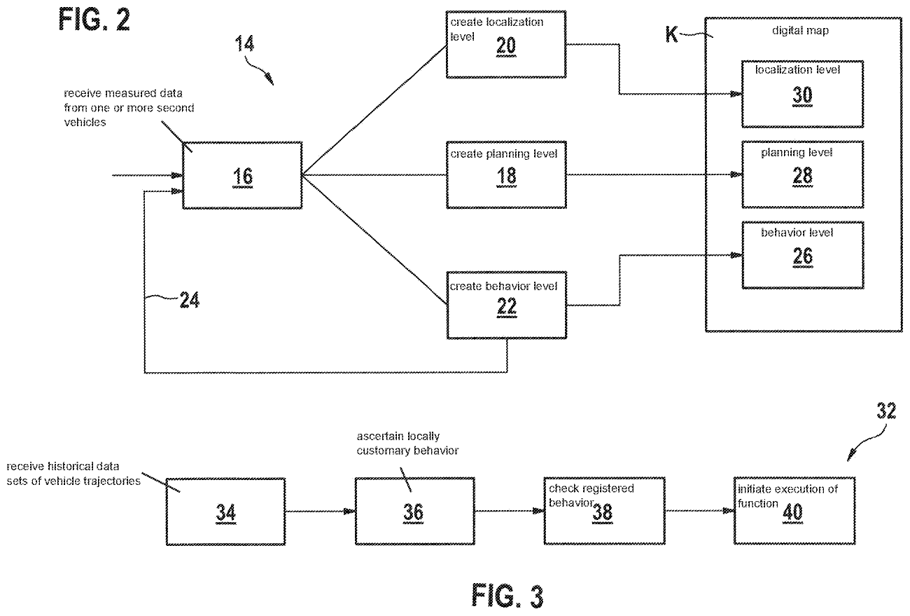

FIG. 2 shows a schematic flow chart for illustrating a utilization 14 of locally customary behavior in a digital map. The mapping of the digital map may, for example, take place by vehicle-external control unit 8.

In a step 16, measured data are received from at least one or multiple second vehicle(s) 10 and locally oriented. In subsequent steps, a creation of a planning level 18 and the creation of a localization level 20 take place.

A behavior level 22 is created during the mapping, in parallel to the creation of the planning level 18 and the creation of the localization level 20.

The digital map thus receives a new layer in which the historical behavior of second vehicles 10 is stored. The historical behavior corresponds to the locally customary behavior and may be utilized 24 for improving the mapping. During the utilization 24, the locally customary behavior or the data of the locally customary behavior may be used to detect, and subsequently correct, errors and deviations in the mapping and the locally oriented measured data of second vehicles 10.

The locally customary behavior is stored in a behavior level 26, in parallel to a planning level 28 and a localization level 30, in digital map K.

FIG. 3 shows a schematic flowchart for illustrating a method 32 for utilizing observed locally customary behavior from historical data sets according to one specific embodiment. Method 32 is used to utilize observed locally customary behavior from historical data sets in vehicle surroundings 1 and may be carried out by a vehicle-external control unit 8 or a vehicle-side control unit 6.

In a step 34, historical data sets of vehicle trajectories of at least one first vehicle 2 and/or at least one second vehicle 10 are received. The historical data set may, in principle, be received or ascertained by all available road users 2, 10, 12.

A locally customary behavior of the at least one first vehicle 2 and/or of the at least one second vehicle 10 is ascertained 36 from the historical data sets.

In a further step 38, a registered behavior of first vehicle 2, of at least one third vehicle 12 or digital map K is checked for deviations, based on the ascertained locally customary behavior.

Thereafter, when a deviation of the locally customary behavior from a registered behavior of first vehicle 2, a registered behavior of a third vehicle 12, or a deviation of the locally customary behavior from digital map K is established, the execution of at least one function 40 is initiated.

What is claimed is:

1. A method for utilizing observed locally customary behavior from historical data sets in vehicle surroundings by a control unit, the method comprising the following steps:
receiving historical data sets of vehicle trajectories of at least one first vehicle and/or of at least one second vehicle;
ascertaining a locally customary behavior of the first vehicle and/or of the second vehicle from the historical data sets;
checking: (i) a registered behavior of the first vehicle or of at least one third vehicle, of (ii) a digital map, for deviations, based on the ascertained locally customary behavior; and
when a deviation of the locally customary behavior from the registered behavior of the first vehicle or the third vehicle, or when a deviation of the locally customary behavior from the digital map is established, initiating execution of at least one function.

2. The method as recited in claim 1, wherein an adaptation of a driving behavior and/or of a trajectory of the first vehicle is carried out as a function of a classification of a digital map or of the third vehicle.

3. The method as recited in claim 1, wherein deviations of the digital map are identified based on a comparison of driving directions and/or speed profiles of the locally customary behavior.

4. The method as recited in claim 1, wherein the ascertained locally customary behavior is checked for deviations for checking ambiguous results in statistic surroundings during a mapping and/or a localization using instantaneously ascertained data sets of a digital map.

5. The method as recited in claim 4, wherein the data sets of the digital maps are classified as not being up-to-date when a deviation is established.

6. The method as recited in claim 3, wherein a classification of the at least one third vehicle is carried out based on the registered behavior of the third vehicle and the comparison to the ascertained locally customary behavior.

7. The method as recited in claim 1, wherein a driving behavior of the first vehicle is adapted to the locally customary behavior when a deviation of the locally customary behavior from the registered behavior of the first vehicle is established.

8. The method as recited in claim 1, wherein the ascertained locally customary behavior is taken into consideration as a prioritized suggestion during an implementation of an automated driving function.

9. The method as recited in claim 8, wherein the ascertained locally customary behavior is taken into consideration during a planning of the automated driving function.

10. A control unit configured to utilize observed locally customary behavior from historical data sets in vehicle surroundings, control unit configured to:
receive historical data sets of vehicle trajectories of at least one first vehicle and/or of at least one second vehicle;
ascertain a locally customary behavior of the first vehicle and/or of the second vehicle from the historical data sets;
check: (i) a registered behavior of the first vehicle or of at least one third vehicle, of (ii) a digital map, for deviations, based on the ascertained locally customary behavior; and
when a deviation of the locally customary behavior from the registered behavior of the first vehicle or the third vehicle, or when a deviation of the locally customary behavior from the digital map is established, initiate execution of at least one function.

11. A non-transitory machine-readable memory medium on which is stored a computer program for utilizing observed locally customary behavior from historical data sets in vehicle surroundings, the computer program, when executed by a computer, causing the computer to perform the following steps:
receiving historical data sets of vehicle trajectories of at least one first vehicle and/or of at least one second vehicle;
ascertaining a locally customary behavior of the first vehicle and/or of the second vehicle from the historical data sets;
checking: (i) a registered behavior of the first vehicle or of at least one third vehicle, of (ii) a digital map, for deviations, based on the ascertained locally customary behavior; and
when a deviation of the locally customary behavior from the registered behavior of the first vehicle or the third vehicle, or when a deviation of the locally customary behavior from the digital map is established, initiating execution of at least one function.
